(19) United States
(12) Patent Application Publication
(10) Pub. No.: US 2013/0014268 A1
(43) Pub. Date: Jan. 10, 2013

(54) STORAGE DEVICE AND STORAGE METHOD

(75) Inventors: Koji AKITA, Kanagawa (JP); Seiichiro HORIKAWA, Kanagawa (JP); Hideo KASAMI, Kanagawa (JP)

(73) Assignee: KABUSHIKI KAISHA TOSHIBA, Tokyo (JP)

(21) Appl. No.: 13/416,552

(22) Filed: Mar. 9, 2012

(30) Foreign Application Priority Data
Jul. 8, 2011 (JP) 2011-151912

(51) Int. Cl. G06F 21/24; G06F 12/14

(52) U.S. Cl. 726/26

(57) ABSTRACT

According to one embodiment, a storage device includes a connector configured to be connected to an equipment; a wireless communication unit configured to transmit and receive data through wireless communication; an identification unit configured to identify the equipment connected to the connector; a storage unit configured to include, for each identified equipment, a restricted area accessible only by the identified equipment; and a controller configured to control the storage unit such that the data, which is received by the wireless communication unit when the equipment is connected to the connector, is written in the restricted area for the connected equipment.

### CROSS-REFERENCE TO RELATED APPLICATION(S)

This application is based upon and claims the benefit of priority from Japanese Patent Application No. 2011-151912, filed on Jul. 8, 2011; the entire contents of which are incorporated herein by reference.

### FIELD

Embodiments described herein relate generally to a storage device and a storage method.

### BACKGROUND

There is known a configuration in which a card includes a memory and a wireless communication function. The card is inserted in an equipment to acquire data using the wireless communication function, which allows the data to be retained in a storage area (memory). That is, even if the equipment has no wireless communication function, by inserting the card, the data, which cannot be acquired without the wireless communication function, can be acquired.

In the case that the equipment includes the wireless communication function, the data can be acquired using the wireless communication function included in the equipment. In this case, the acquired data is retained in the memory incorporated in the equipment. In the case that the data is a nonfree content, or in the case that the data is a copyright protection content, it is necessary to prevent an unauthorized copy of the data. The copy of the data retained in the memory can be prevented because it is relatively difficult to dismount the memory incorporated in the equipment.

However, in the case that the card including the memory and the wireless communication function is inserted in the equipment and data, which is acquired using the wireless communication function, is retained in the memory incorporated in the card, the data is easily copied because the card can easily be detached and connected to another equipment. In the conventional art, in the case that the data acquired using the wireless communication function of the card is retained in the memory incorporated in the card, it is difficult to prevent the copy of the data.

### BRIEF DESCRIPTION OF THE DRAWINGS

FIG. 1 is a block diagram of a communication system according to a first embodiment;

FIG. 2 is a block diagram of a communication system according to a first modification of the first embodiment;

FIG. 3 is a block diagram of a card of the first embodiment;

FIG. 4 is a block diagram of a card according to a second modification of the first embodiment;

FIG. 5 is a block diagram of a card according to a second embodiment;

FIG. 6 is a block diagram of a card according to a first modification of the second embodiment;

FIG. 7 is a sequence diagram of data storage process according to the second modification of the second embodiment; and

FIG. 8 is a sequence diagram of data storage process according to a third modification of the second embodiment.

### DETAILED DESCRIPTION

According to one embodiment, a storage device includes a connector configured to be connected to an equipment; a wireless communication unit configured to transmit and receive data through wireless communication; an identification unit configured to identify the equipment connected to the connector; a storage unit configured to include, for each identified equipment, a restricted area accessible only by the identified equipment; and a controller configured to control the storage unit such that the data, which is received by the wireless communication unit when the equipment is connected to the connector, is written in the restricted area for the connected equipment.

Various embodiments will be described below in detail with reference to the accompanying drawings.

### First Embodiment

A storage device according to a first embodiment is a card-shaped storage device such as a memory card. The storage device is utilizable by being inserted in an equipment such as a mobile phone and a PC (Personal Computer). As the card, an SD card, a micro SD card, an SIM card, and an IC card can be used, for example. Although the card type storage device is described below by way of example, the shape of the storage device is not limited to the card shape. Even if the storage device does not have the card shape, the first embodiment may be applied to any storage device that becomes utilizable by being connected to the equipment.

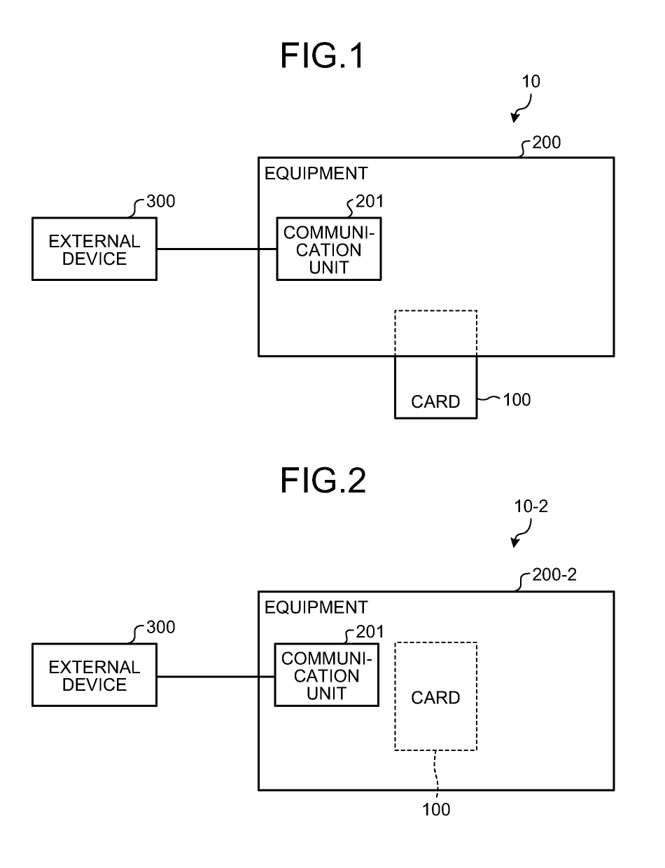

FIG. 1 is a block diagram illustrating an example of a configuration of a communication system 10 including a card 100 that is the storage device according to the first embodiment. As illustrated in FIG. 1, the communication system 10 includes the card 100, an equipment 200, and an external device 300.

The equipment 200 includes a slot (not illustrated) that is used to connect the card 100 and a communication unit 201. The communication unit 201 transmits and receives various pieces of data to and from devices such as the external device 300. Any known method can be applied to a communication method performed by the communication unit 201. For example, the communication unit 201 can be configured to communicate with the external device 300 through either one or both of wired communication and wireless communication.

For example, the card 100 is connected to the equipment 200 by being inserted in the slot of the equipment 200. The card 100 connected to the equipment 200 can be utilized as the storage device identical to a storage device (not illustrated) that is previously incorporated in the equipment 200.

FIG. 2 is a block diagram illustrating an example of a configuration of a communication system 10-2 according to a first modification of the first embodiment. As illustrated in FIG. 2, the communication system 10-2 includes the card 100, an equipment 200-2, and the external device 300. In the configuration of the first modification, the equipment 200-2 is connected to the card 100 by being fully inserted in the card 100.

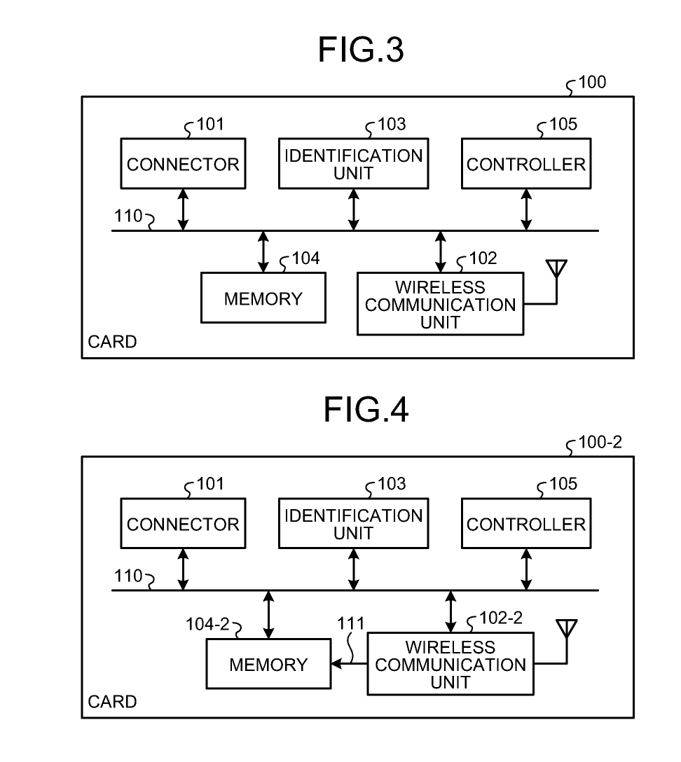

FIG. 3 is a block diagram illustrating a configuration example of the card 100 of the first embodiment. As illustrated in FIG. 3, the card 100 includes a connector 101, a wireless communication unit 102, an identification unit 103, a memory 104, a controller 105, and a bus 110.

The bus 110 connects the connector 101, the wireless communication unit 102, the identification unit 103, the memory 104, and the controller 105 to one another. The bus 110 is used in transmission and reception of data among the connected units.

The connector 101 connects the card 100 and the equipment 200 to each other. For example, the connector 101 includes a terminal corresponding to a terminal of the slot of the equipment 200 and is electrically connected to the equipment 200 via the terminal.

The wireless communication unit 102 transmits and receives the data through wireless communication. For example, the wireless communication unit 102 conducts the wireless communication according to a wireless communication method such as Transfer Jet, NFC, millimeter-wave wireless communication, or wireless LAN.

The identification unit 103 identifies the equipment 200 connected to the connector 101. For example, the identification unit 103 identifies the equipment 200 using an identifier (identification information) unique to the equipment 200. An MAC address of a wireless communication function (communication unit 201) mounted on the equipment 200 can be used as the identifier unique to the equipment 200. Alternatively, the identification unit 103 may be configured to identify the equipment 200 through authentication process with an authentication card inserted in the equipment 200. For example, the identification unit 103 may use information (such as an ID number), which is unique to the authentication card acquired through the authentication process with the authentication card, as the identifier unique to the equipment 200. The authentication card may be an SIM card that is used by being inserted in a mobile phone, for example. Alternatively, the authentication card may be a B-CAS card or an IC card.

The memory 104 is a storage unit that stores therein the data. For example, the memory 104 stores therein the data received by the wireless communication unit 102. The memory 104 may store therein the data received from the equipment 200 through the connector 101. The memory 104 includes, for each equipment 200, a restricted area accessible only by the equipment 200 in its storage area where the data is stored.

For example, the memory 104 manages the restricted area for each equipment 200 using a table in which the identifier of the equipment 200 is associated with an address of the restricted area. The restricted area for each equipment 200 may be set in advance. Alternatively, when the equipment 200 is identified, the restricted area corresponding to the identifier of the identified equipment 200 may newly be allocated. The memory 104 may not manage the restricted area for each equipment 200. Instead, another unit (for example, the controller 105) outside the memory 104 may manage the restricted area for each equipment 200.

The controller 105 controls whether the data acquired from the wireless communication unit 102 is to be written in the restricted area or in an area other than the restricted area. For example, the controller 105 controls the memory 104 such that, when the equipment 200 is connected to the connector 101, the data received by the wireless communication unit 102 is written in the restricted area corresponding to the connected equipment 200.

More particularly, when the identification unit 103 identifies the equipment 200 after the equipment 200 is connected, the controller 105 performs the control such that the data is to be written in the restricted area that is accessible only from the equipment 200. “The equipment 200 is connected” means the case that the card is connected by being inserted in the slot of the equipment 200 as illustrated in FIG. 1 or the case that the card is connected by being fully inserted in the equipment 200 as illustrated in FIG. 2.

For example, the controller 105 controls the memory 104 such that the data transmitted from the wireless communication unit 102 is written in the restricted area. In this case, for example, the controller 105 instructs the memory 104 to write the data in the restricted area. In response to the instruction from the controller 105, the memory 104 writes the data transmitted from the wireless communication unit 102 in the restricted area corresponding to the identifier of the connected equipment 200.

Alternatively, the controller 105 may control the wireless communication unit 102 such that the wireless communication unit 102 requests the memory 104 to write the data in the restricted area. In this case, in response to the request from the wireless communication unit 102, the memory 104 writes the data transmitted from the wireless communication unit 102 in the restricted area corresponding to the identifier of the connected equipment 200.

Furthermore, the controller 105 may control such that the data is written in an area other than the restricted area in response to a request from equipment 200 identified by the identification unit 103. For example, there is a case in which it can be determined whether the data acquired by the wireless communication unit 102 is permitted to be copied during execution of service executed by the connected equipment 200. In such a case, when it is determined that the data is permitted to be copied, the equipment 200 may be configured to notify the controller 105 in the card 100 that the data is to be written in the area other than the restricted area. When receiving the notification, the controller 105 performs the control such that the data received by the wireless communication unit 102 is stored in the area other than the restricted area.

Inversely, only when the equipment 200 makes the request, the controller 105 may perform the control such that the data is written in the restricted area.

After performing the control such that the write destination of the data is set to the restricted area, the controller 105 may reset the control at a time the connection between the card 100 and the equipment 200 is disconnected. That is, the data may be permitted to be written in the area other than the restricted area. Alternatively, after the controller 105 performs the control such that the write destination of the data is set to the restricted area, the controller 105 may reset the control in response to a request from the connected equipment 200.

The wireless communication unit 102 transmits the data to the memory 104 through the bus 110. There is no particular limitation to the data transmission method. For example, the data may be transmitted through a point-to-point signal line. FIG. 4 is a block diagram illustrating a configuration example of a card 100-2 according to a second modification of the first embodiment. As illustrated in FIG. 4, in the second modification, a wireless communication unit 102-2 transmits the data to a memory 104-2 through a point-to-point signal line 111.

When the identification unit 103 cannot identify the equipment 200, the data may be discarded without being written in the memory 104 even when the card is being connected to the equipment 200. This prevents the unauthorized copy of the data.

As described above, according to the card of the first embodiment, the data can be written in the restricted area that is accessible only by the connected equipment. Therefore, in the case that the card is inserted in another equipment after the data acquired using the wireless communication function included in the card is retained in the memory incorporated in the card, the data is not accessible from another equipment. Accordingly, the data, which is written during connection to a certain equipment, can be prevented from being copied to another equipment.

### Second Embodiment

For example, in the case that the nonfree data is acquired, it is necessary to make a payment to purchase the data. In the case of the electronic payment, it is necessary to perform authentication process in payment. In the case that the nonfree data is received by the wireless communication unit subsequent to the authentication process, it is desirable that the unauthorized copy of the data be prevented. In a second embodiment, a configuration of a storage device including a function of performing the authentication process will be described.

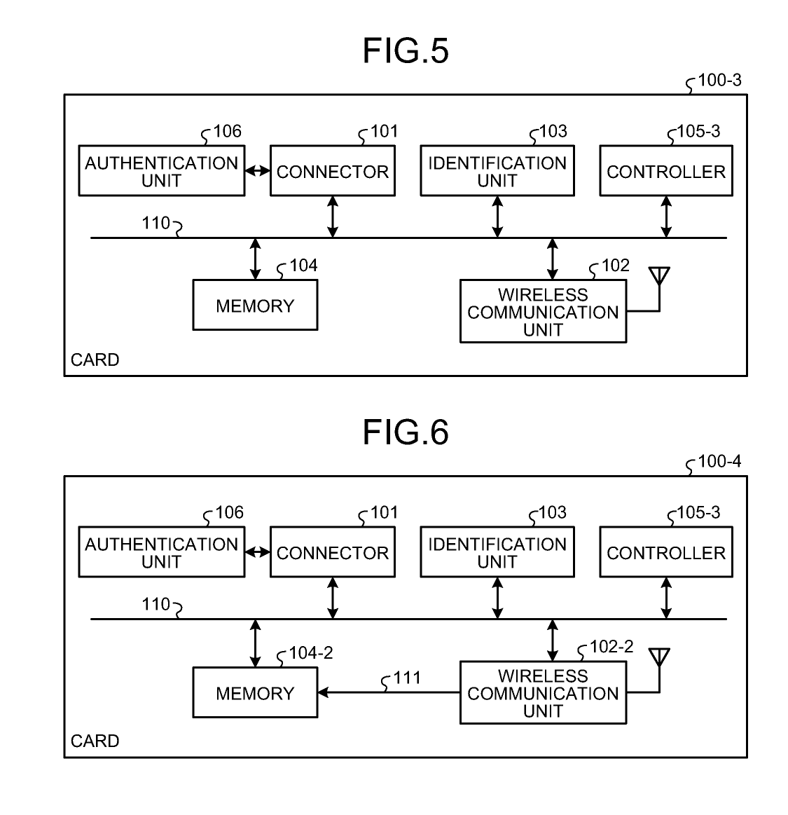

FIG. 5 is a block diagram illustrating a configuration example of a card 100-3 of the second embodiment. As illustrated in FIG. 5, the card 100-3 includes the connector 101, the wireless communication unit 102, the identification unit 103, the memory 104, a controller 105-3, the bus 110, and an authentication unit 106.

The second embodiment differs from the first embodiment in a function of the controller 105-3 and addition of the authentication unit 106. Because other configurations and functions are identical to those of the block diagram of FIG. 3 illustrating the card 100 of the first embodiment, the same component is designated by the same numeral, and the description will not be repeated.

The authentication unit 106 performs the authentication process of authenticating the card 100-3 through communication with the outside of the card, such as the external device 300. For example, the authentication unit 106 performs the payment-related authentication process in conjunction with the external device 300. For example, the authentication unit 106 may be constructed by a secure element. For example, the authentication unit 106 may perform the authentication process according to a single wire protocol (SWP). In the case of use of the SWP, the authentication unit 106 is connected to the outside not through the bus 110 but through the connector 101. In the case that another authentication method is used, the authentication unit 106 may be configured to be connected to another component through the bus 110.

The controller 105-3 performs the authentication process through the equipment 200 identified by the identification unit 103, and then performs the control such that the data received by the wireless communication unit 102 during the connection to the equipment 200 is written in the restricted area. Before the authentication process is performed, the controller 105-3 performs the control such that the data received by the wireless communication unit 102 is prohibit from being written in the restricted area even if the equipment 200 connected to the connector 101 is identified and even if the equipment 200 is being connected.

With such configuration, the unauthorized copy of the nonfree data, which is received after the authentication process for the payment, can be prevented.

FIG. 6 is a block diagram illustrating a configuration example of a card 100-4 according to a first modification of the second embodiment. In the card 100-4 of the first modification, similarly to the second modification of the first embodiment, the wireless communication unit 102-2 transmits the data to the memory 104-2 through the point-to-point signal line 111.

The wireless communication unit 102-2 may further include a notification unit configured to notify the other communication end whether the controller 105-3 controls the data to be written in the restricted area. With this, the equipment on the other communication end can find whether the card is provided for the write of the data in the restricted area. This prevents the unauthorized copy with high accuracy.

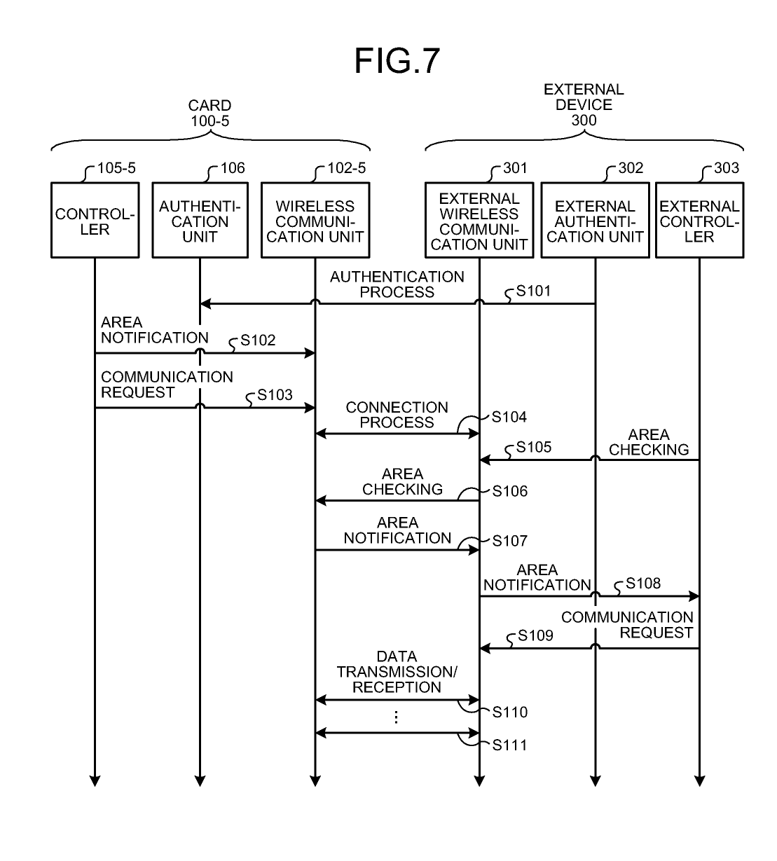

FIG. 7 is a sequence diagram illustrating an example of data storage process performed by a card 100-5 according to a second modification of the second embodiment as configured above.

As illustrated in FIG. 7, the card 100-5 includes a controller 105-5, the authentication unit 106, and a wireless communication unit 102-5. Although not illustrated in FIG. 7, similarly to the card 100-3 in FIG. 5, the card 100-5 also includes the connector 101, the identification unit 103, the memory 104, and the bus 110. The card 100-5 of the second modification differs from the card 100-3 of the second embodiment in functions of the controller 105-5 and the wireless communication unit 102-5.

The controller 105-5 further includes a function of transmitting in advance, to the wireless communication unit 102-5, a notification (hereinafter referred to as an area notification) indicating whether the data is to be written in the restricted area. The wireless communication unit 102-5 further includes a function of transmitting the area notification to the external device 300 in response to the request from the external device 300.

As illustrated in FIG. 7, the external device 300 includes an external wireless communication unit 301, an external authentication unit 302, and an external controller 303. The external wireless communication unit 301 transmits and receives the data to and from the wireless communication unit 102-5 through the wireless communication. The external authentication unit 302 performs the authentication process in conjunction with the authentication unit 106. The external controller 303 controls various processes necessary to write the data to the card 100-5.

The authentication unit 106 performs the authentication process in conjunction with the external authentication unit 302 (Step S101). When the authentication process is normally completed, the controller 105-5 transmits, to the wireless communication unit 102-5, the area notification indicating that the data is to be written in the restricted area (Step S102). The controller 105-5 transmits a request to the wireless communication unit 102-5 to start the communication with the external device 300 for the purpose of the data transmission/reception (Step S103). In response to the request, the wireless communication unit 102-5 performs the connection process in conjunction with the external wireless communication unit 301 (Step S104).

The external controller 303 checks with the wireless communication unit 102-5 whether the data is to be stored in the restricted area through the external wireless communication unit 301 (Steps S105 and S106). The wireless communication unit 102-5 transmits in advance the area notification to the external wireless communication unit 301 (Step S107). The external wireless communication unit 301 transmits the received area notification to the external controller 303 (Step S108).

For example, when it is confirmed, based on the area notification, that the data is to be stored in the restricted area, the external controller 303 transmits the request to the external wireless communication unit 301 to start the communication for the purpose of the data transmission/reception (Step S109). Then the external wireless communication unit 301 transmits and receives the data to and from the wireless communication unit 102-5 (Steps S110 and S111).

The area notification may indirectly suggest whether the controller 105-5 controls the data to be written in the restricted area. For example, the area notification indicates that the data is to be written in the restricted area for a period during which the card 100-5 is inserted in the equipment 200, whereby the area notification can indirectly indicate that the controller 105-5 controls the data to be written in the restricted area. Alternatively, in the case that a standard complied with by the controller 105-5 defines that the data is to be written in the restricted area, the area notification may indicates that the controller 105-5 complies with the standard.

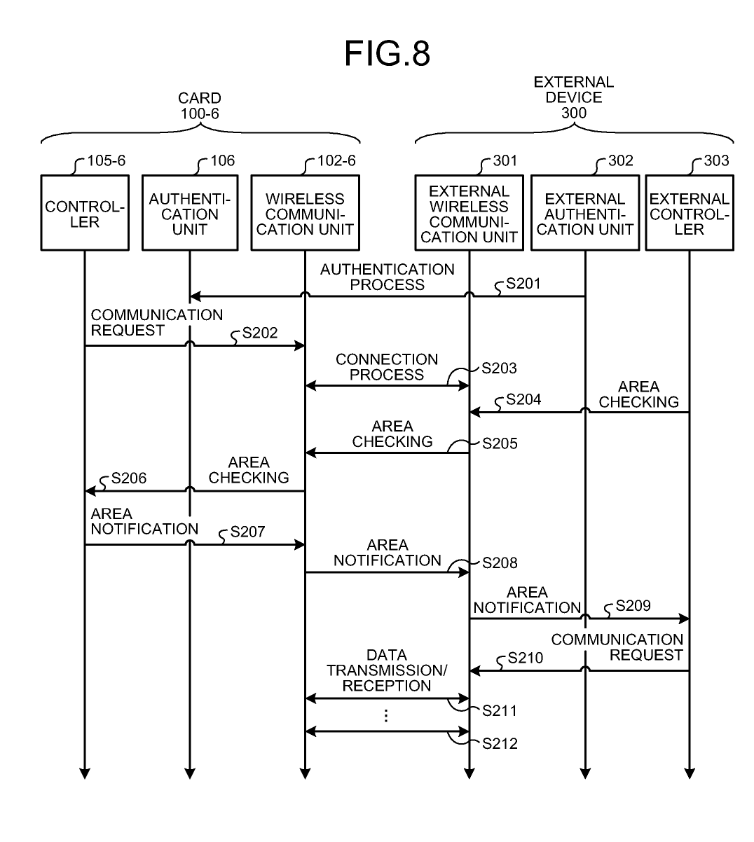

In FIG. 7, the controller 105-5 transmits in advance the area notification to the wireless communication unit 102-5. Alternatively, the area notification may be transmitted in response to a request from the outside of the card. FIG. 8 is a sequence diagram illustrating an example of data storage process performed by a card 100-6 according to a third modification of the second embodiment.

Steps S201 to S205 in FIG. 8 are identical to Steps S101 and S103 to S106 in FIG. 7. In the third modification, when the request to check whether the data is to be stored in the restricted area is received from the external device 300 (Step S205), a wireless communication unit 102-6 further makes the request to a controller 105-6 to check whether the data is to be stored in the restricted area (Step S206). When receiving the checking request from the wireless communication unit 102-6, the controller 105-6 transmits the area notification to the wireless communication unit 102-6 (Step S207).

Steps S208 to S212 in FIG. 8 are identical to Steps S107 to S111 in FIG. 7.

In the second modification (FIG. 7) of the second embodiment and the third modification (FIG. 8) of the second embodiment, the area notification may be transmitted and received not through the wireless communication unit 102-5 but through the connector 101.

As described above, according to the first and second embodiments, the unauthorized copy of the data acquired by the wireless communication function included in the card can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a connector capable to be connected to an equipment;
a wireless communication unit configured to transmit and receive data through wireless communication;
an identification unit configured to identify an equipment connected to the connector;
a storage unit configured to include, for each identified equipment, a restricted area accessible only by the identified equipment; and
a controller configured to control the storage unit such that data, which is received by the wireless communication unit when the identified equipment is connected to the connector, can be written in the restricted area for the identified equipment.

2. The device according to claim 1, further comprising an authentication unit configured to perform authentication process of the storage device through the identified equipment,
wherein the controller controls the storage unit such that data, which is received by the wireless communication unit when the identified equipment is connected to the connector, is prohibited from being written in the restricted area for the identified equipment before the storage device is authenticated through the authentication process.

3. The device according to claim 1, wherein, when a request to write data in the restricted area is made through the identified equipment, the controller controls the storage unit such that data, which is received by the wireless communication unit when the identified equipment is connected to the connector, is written in the restricted area for the identified equipment.

4. The device according to claim 1, wherein the identification unit identifies the equipment using identification information unique to the equipment.

5. The device according to claim 1, wherein the identification unit identifies the equipment using identification information stored in a card inserted in the equipment.

6. The device according to claim 1, further comprising a notification unit configured to notify that the controller controls the storage unit to write data in the restricted area.

7. The device according to claim 1, wherein the storage device is a memory card.

8. A storage method performed by a storage device, the storage device including a connector capable to be connected to an equipment, a wireless communication unit configured to transmit and receive data through wireless communication, and a storage unit configured to include, for each equipment, a restricted area accessible only by the equipment,
the storage method comprising:
identifying the equipment connected to the connector; and
controlling the storage unit such that data, which is received by the wireless communication unit when the equipment is connected to the connector, is written in the restricted area for the equipment.
